(19) United States
(12) Patent Application Publication
(10) Pub. No.: US 2007/0222949 A1
(43) Pub. Date: Sep. 27, 2007

(54) Light combining/projecting system for outputting light beams of the same polarization

(76) Inventors: Liu-Liang Liao, Hsinchu (TW); Yen-Te Lee, Hsinchu (TW); Yu-Ta Chung, Hsinchu (TW); Kuang-Huang Huang, Hsinchu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/389,193

(22) Filed: Mar. 27, 2006

(51) Int. Cl. G03B 21/14

(52) U.S. Cl. 353/20

(57) ABSTRACT

A light combining/projecting system for outputting light beams of the same polarization includes a light-emitting module, a dichroic mirror, a reflective mirror module, a PBS module, an image-displaying module, and a light-combining module. The PBS module has a first, a second, and a third PBS respectively and integratedly arranged on three sides of the dichroic mirror. The image-displaying module has a first, a second, and a third image-displaying panel respectively arranged beside the first, the second, and the third PBS. The reflective mirror module has a first, a second, and a third reflective mirror under the first, the second, and the third PBS. The dichroic mirror is arranged at a corner position between the second and the third PBS. The light-combining module, the PBS module, the image-displaying module, the reflective mirror module, and the dichroic mirror are all mated together for generating light beams of the same polarization.

### BACKGROUND OF THE INVENTION

1. Field of The Invention

The present invention relates to a light combining/projecting system for outputting light beams of the same polarization, and particularly relates to a light-emitting module, a dichroic mirror, a reflective mirror module, a PBS module, an image-displaying module, and a light-combining module all mated together for generating light beams of the same polarization.

2. Description of the Related Art

Due to the development of optical and projection display technology, digital projection devices with a high number of dots per inch and pixels are often used for briefings, meetings, conferences or trainings. They have also become an important apparatus for family entertainment. Such potential consumers look for a lightweight digital projection apparatuses with high image quality and brightness, all at, of course, a reasonable price.

Referring to FIGS. 1 and 2, a known light combining/projecting system includes an X-cube 1a, a first and a second ½-wave plate (21a and 22a), a first, a second, and a third PBS (Polarizing Beam Splitter) (31a, 32a and 33a), a first, a second, and a third LCOS panel (41a, 42a and 43a), and a dichroic mirror 5a.

The ½-wave plates 21a, 22a are polarization conversion elements, and the ½-wave plates 21a, 22a are respectively arranged on two opposite sides of the X-cube 1a. The first PBS 31a is arranged on the ½-wave plate 21a, the second PBS 32a is arranged on another side of the X-cube 1a, and the third PBS 33a is arranged on the ½-wave plate 22a. The first, the second, and the third LCOS panel (41a, 42a and 43a) are arranged beside the first, the second, and the third PBS (31a, 32a and 33a), respectively. In addition, the dichroic mirror 5a is arranged at a corner position between the second PBS 32a and the third PBS 33a.

Referring to FIG. 2 which is a front showing the present invention providing a first light-emitting element 61a for generating a blue polarizing beam, meaning an s-polarization blue (B) polarizing beam Bs (the line with small circles). The Bs is received and reflected to the first LCOS panel 41a via the first PBS 31a. The Bs is then transformed into a p-polarization blue (B) polarizing beam Bp with images (the line with horizontal arrows) via the first LCOS panel 41a. In addition the Bp with images is transformed into the Bs with images.

According to the same principle, the present invention provides a second light-emitting element 62a for generating a green/red polarizing beam, meaning an s-polarization G/R (Green/Red) polarizing beam Gs/Rs (the line with small circles). The Gs/Rs is separated into an s-polarization G (Green) polarizing beam Gs and an s-polarization R (Red) polarizing beam Rs by the dichroic mirror 5a. Moreover, the Gs and the Rs are received and reflected to the second and the third LCOS panel 42a, 43a via the second and the third PBS 32a, 33a, respectively. The Gs and the Rs are respectively transformed into a p-polarization G polarizing beam Gp with images (the line with horizontal arrows) and a p-polarization R polarizing beam Rp with images (the line with horizontal arrows) via the second and the third LCOS panel 42a, 43a. In addition the Rp with images is transformed into the Rs with images.

Finally, the Bs with images, the Gp with images, and the Rs with images are combined and projected out via the X-cube 1a.

However, the Bs with images, the Gp with images, and the Rs with images do not have the same polarization. Hence known projectors can not display a uniform frame. Besides, the first and the second ½-wave plates 21a, 22a are not only more expensive, they also create stress due to the position and heat-dissipating problems regarding the first and the second ½-wave plates 21a, 22a. Hence the quality of the projected frame is affected.

### SUMMARY OF THE INVENTION

The present invention provides a light combining/projecting system for outputting light beams of the same polarization. The system includes a light-emitting module, a dichroic mirror, a reflective mirror module, a PBS module, an image-displaying module, and a light-combining module all mated together for generating light beams of the same polarization. Furthermore, the present invention does not require the first and the second ½-wave plates of the prior art. Hence, not only are costs reduced and stress upon the projector reduced, but also the present invention provides uniform frames due to the light beams being of the same polarization.

One first aspect of the invention is a light combining/projecting system for outputting light beams of the same polarization. The system comprises a light-emitting module, a dichroic mirror, a reflective mirror module, a PBS module, an image-displaying module, and a light-combining module. The light-emitting module is used to generate two predetermined light beams. The dichroic mirror is arranged beside one side of the light-emitting module for separating one of the two predetermined light beams into a first color light beam and a second color light beam.

Moreover the reflective mirror module has a first, a second, and a third reflective mirror. The first reflective mirror is arranged beside one side of the dichroic mirror for receiving and reflecting the first color light beam from the dichroic mirror, the second reflective mirror is arranged beside the other side of the dichroic mirror for receiving and reflecting the second color light beam from the dichroic mirror, and the third reflective mirror is opposite to the first reflective mirror for receiving and reflecting the other predetermined light beam that is a third color light beam.

Furthermore the PBS module has a first, a second, and a third PBS respectively arranged over the first, the second, and the third reflective mirror for respectively receiving and reflecting the first, the second, and the third color light beams from the first, the second, and the third reflective mirror. The image-displaying module has a first, a second, and a third image-displaying panel respectively arranged beside the first, the second, and the third PBS to respectively receive and reflect the first, the second, and the third color light beams from the first, the second, and the third PBS for respectively generating a first, a second and a third color image light beam. The light-combining module is integratedly jointed among the first, the second, and the third PBS for respectively receiving and projecting the first, the second, and the third color image light beams from the first, the second, and the third image-displaying panel.

It is to be understood that both the foregoing general description and the following detailed description are exemplary, and are intended to provide further explanation of the invention as claimed. Other advantages and features of the invention will be apparent from the following description, drawings and claims.

### BRIEF DESCRIPTION OF THE DRAWINGS

The various objectives and advantages of the present invention will be more readily understood from the following detailed description when read in conjunction with the appended drawing, in which:

FIG. 1 is a perspective, schematic view of a light combining/projecting system according to the prior art;

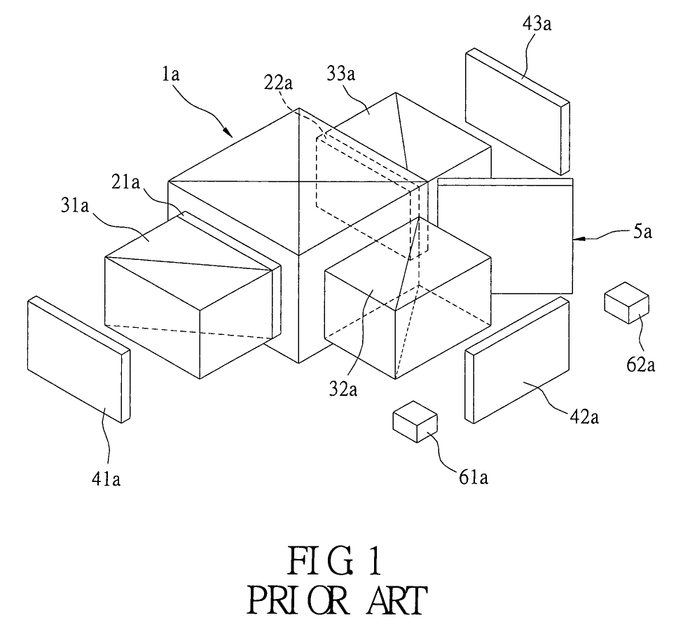

FIG. 2 is a top, schematic view of a light combining/projecting system according to the prior art;

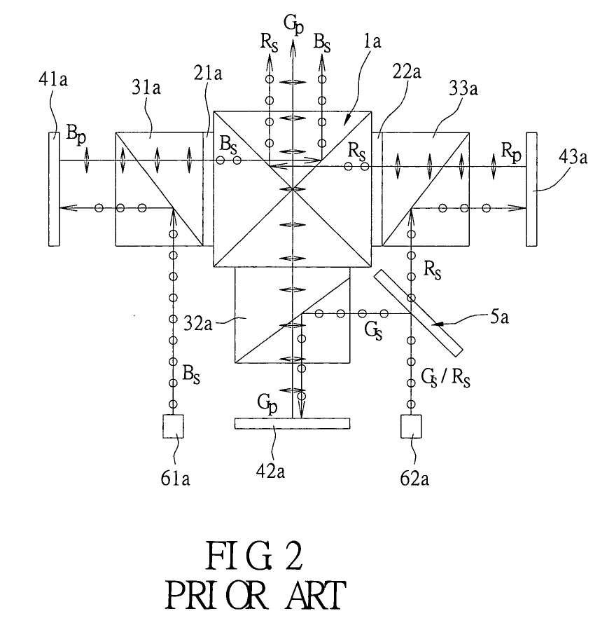

FIG. 3 is a perspective, schematic view of a light combining/projecting system for outputting light beams of the same polarization according to the present invention;

FIG. 4 is a top, schematic view of a light combining/projecting system for outputting light beams of the same polarization according to the present invention;

FIG. 5 is a front, schematic view of a light combining/projecting system for outputting light beams of the same polarization according to the present invention;

FIG. 6 is a side, schematic view of a light combining/projecting system for outputting light beams of the same polarization according to the present invention; and

FIG. 7 is a flowchart of a method for a light combining/projecting system to output light beams of the same polarization according to the present invention.

### DETAILED DESCRIPTION OF PREFERRED EMBODIMENTS

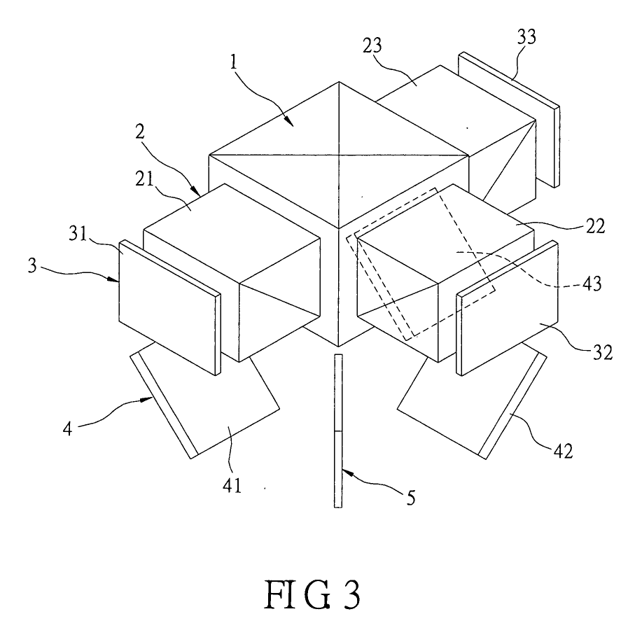

Referring to FIGS. 3 to 6, the present invention provides a light combining/projecting system for outputting light beams of the same polarization, comprising a light-combining module 1, a PBS module 2, an image-displaying module 3, a reflective mirror module 4, and a dichroic mirror 5.

The PBS module 2 has a first, a second, and a third PBS (21, 22 and 23) respectively integrated arranged on three faces of the light-combining module 1 that can be an X-cube.

Moreover, the image-displaying module 3 has a first, a second and a third image-displaying panel (31, 32 and 33) respectively arranged beside the first, the second, and the third PBS (21, 22 and 23), and the image-displaying panel (31, 32 and 33) can be LCOS panel.

Furthermore, the reflective mirror module 4 has a first, a second, and a third reflective mirror (41, 42 and 43) respectively arranged under the first, the second, and the third PBS (21, 22 and 23). The dichroic mirror 5 is arranged at a corner position between the first reflective mirror 41 and the second reflective mirror 42. Moreover the system further comprises a light-emitting module 6 having a first light-emitting element 61 and a second light-emitting element for respectively generating two predetermined light beams.

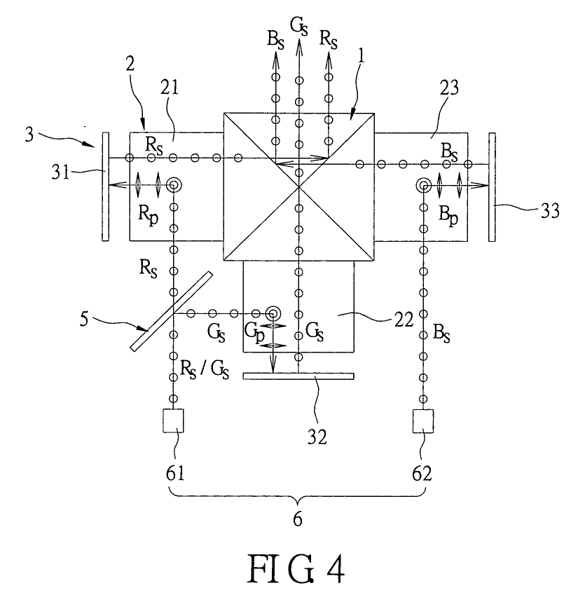

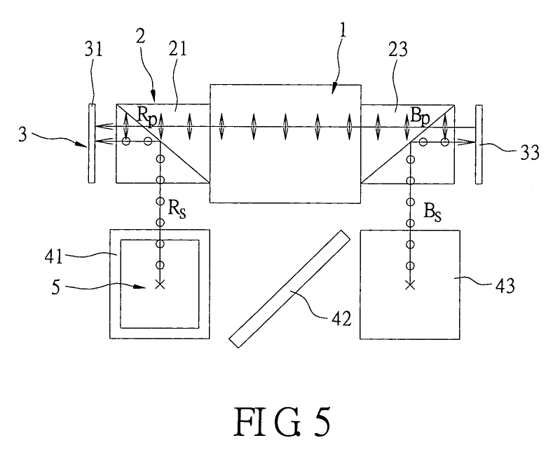

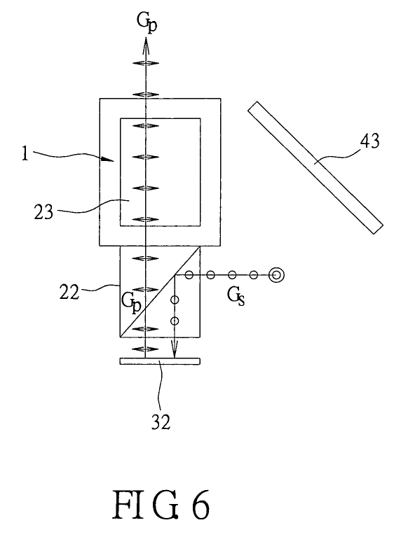

Returning to FIGS. 4 and 6, a method for the light combining/projecting system to output light beams of the same polarization is described as follows: firstly, the first light-emitting element 61 is used to generate a red/green polarizing beam that in front view of FIG. 4 means an s-polarization R/G (Red/Green) polarizing beam Rs/Gs (the line with small circles). The Rs/Gs is then separated into an s-polarization R (Red) polarizing beam Rs and an s-polarization G (Green) polarizing beam Gs by the dichroic mirror 5. Alternatively, referring to FIG. 5, the Rs/Gs (the X symbol) is projected to the dichroic mirror 5. In FIG. 6, the Gs (the ⊚ symbol) is reflected from the dichroic mirror 5.

Referring to FIG. 4, both the Rs (the ⊚ symbol) and the Gs (the ⊚ symbol) are reflected and upwardly projected to the first PBS 21 and the second PBS 22 via the first reflective mirror 41 and the second reflective mirror 42, respectively. Alternatively, referring to FIG. 5, the Rs (the ⊚ symbol) is reflected and projected to the first PBS 21 via the first reflective mirror 41, and, referring to FIG. 6, the Gs (the ⊚ symbol) is reflected and projected to the second PBS 22 via the second reflective mirror 42 (not shown in FIG. 6).

Moreover, referring to FIG. 4, a p-polarization R (Red) polarizing beam Rp (the line with horizontal arrows) and a p-polarization G (Green) polarizing beam Gp (the line with horizontal arrows) are respectively reflected to the first image-displaying panel 31 and the second image-displaying panel 32 via the first PBS 21 and the second PBS 22. Alternatively, referring to FIG. 5, the Rs is reflected to the first image-displaying panel 31 via the first PBS 21, and referring to FIG. 6, the Gs is reflected to the second image-displaying panel 32 via the second PBS 22.

Furthermore, referring to FIG. 4, the Rp and the Gp are respectively transformed into an s-polarization R polarizing beam Rs with images (the line with small circles) and an s-polarization G polarizing beam Gs with images (the line with small circles) via the first and the second image-displaying panel 31, 32. Alternatively, referring to FIG. 5, the Rs is transformed into a p-polarization R polarizing beam Rp with images via the first image-displaying panel 31, and referring to FIG. 6, the Gs is transformed into a p-polarization R polarizing beam Gp with images via the second image-displaying panel 32.

In addition, the second light-emitting element 62 is used to generate a blue polarizing beam (shown using a front view of FIG. 4), meaning an s-polarization blue (B) polarizing beam Bs (the line with small circles). Alternatively, referring to FIG. 5, the Bs (the X symbol) is projected to the third reflective mirror 43. Alternatively, referring to FIG. 6, the Bs is generated from the second light-emitting element 62.

Furthermore, referring to FIG. 4, the Bs (the ⊚ symbol) is reflected and upwardly projected to the third PBS 23 via the third reflective mirror 43. Alternatively, referring to FIG. 5, the Bs (the ⊚ symbol) is reflected and upwardly projected to the third PBS 23 via the third reflective mirror 43.

Moreover, referring to FIG. 4, a p-polarization B polarizing beam Bp (the line with horizontal arrows) is reflected to the third image-displaying panel 33 via the third PBS 23. Alternatively, referring to FIG. 5, the Bs is reflected to the third image-displaying panel 33 via the third PBS 23.

Furthermore, referring to FIG. 4, the Bp is transformed into an s-polarization B polarizing beam Bs with images (the line with small circles) via the third image-displaying panel 33. Alternatively, referring to FIG. 5, the Bs is transformed into an s-polarization B polarizing beam Bp with images (the line with small circles) via the third image-displaying panel 33.

Finally, referring to FIG. 4, the Rs with images, the Gs with images, and the Bs with images are combined and projected out via the light-combining module 1. Alternatively, referring to FIGS. 5 and 6, the Rp with images, the Gp with images, and the Bp with images are combined and projected out via the light-combining module 1. In addition, the above-mentioned light beam includes s-polarization and p-polarization polarizing beams. The difference between the s-polarization polarizing beams and the p-polarization polarizing beams are dependant upon their respective different visual angles (such as vertical direction and horizontal direction).

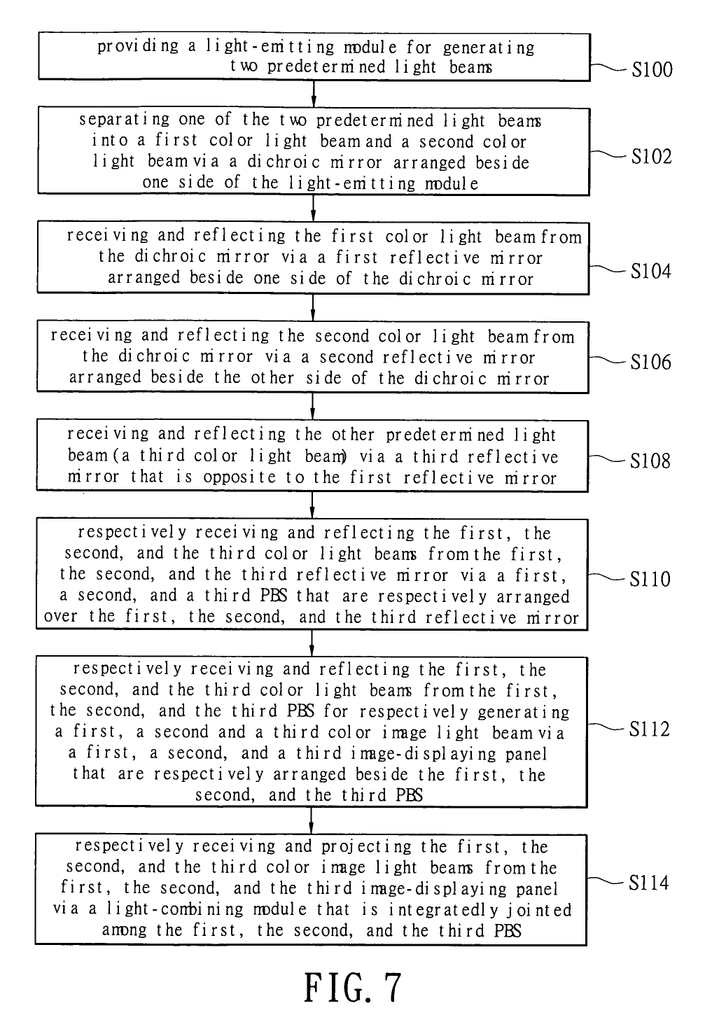

FIG. 7 shows a flowchart of a method for a light combining/projecting system to output light beams of the same polarization according to the present invention. In conclusion, the light-combining module 1, the PBS module 2, the image-displaying module 3, the reflective mirror module 4, and the dichroic mirror 5 all mated together for generating light beams of the same polarization. Furthermore, the present invention does not require the first and the second ½-wave plates (21a, 22a) used in the prior art. Hence, not only is the system cheaper, but less stress is placed upon the system, and the present invention also provides uniform frames as the light beams all have the same polarization.

Although the present invention has been described with reference to the preferred embodiments thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A light combining/projecting system for outputting light beams of the same polarization, comprising:
a light-emitting module for generating two predetermined light beams;
a dichroic mirror arranged beside one side of the light-emitting module for separating one of the two predetermined light beams into a first color light beam and a second color light beam;
a reflective mirror module having a first, a second, and a third reflective mirror, wherein the first reflective mirror is arranged beside one side of the dichroic mirror for receiving and reflecting the first color light beam from the dichroic mirror, the second reflective mirror is arranged beside the other side of the dichroic mirror for receiving and reflecting the second color light beam from the dichroic mirror, and the third reflective mirror is opposite to the first reflective mirror for receiving and reflecting the other predetermined light beam that is a third color light beam;
a PBS module having a first, a second, and a third PBS respectively arranged over the first, the second, and the third reflective mirror for respectively receiving and reflecting the first, the second, and the third color light beams from the first, the second, and the third reflective mirror;
an image-displaying module having a first, a second, and a third image-displaying panel respectively arranged beside the first, the second, and the third PBS to respectively receive and reflect the first, the second, and the third color light beams from the first, the second, and the third PBS for respectively generating a first, a second and a third color image light beam; and
a light-combining module integratedly jointed among the first, the second, and the third PBS for respectively receiving and projecting the first, the second, and the third color image light beams from the first, the second, and the third image-displaying panel.

2. The system as claimed in claim 1, wherein the light beam is a polarizing light beam.

3. The system as claimed in claim 1, wherein the first, the second, and the third image-displaying panel are LCOS panel.

4. The system as claimed in claim 1, wherein the light-combining module is an X-cube.
